(19) United States
(12) Patent Application Publication
(10) Pub. No.: US 2015/0354278 A1
(43) Pub. Date: Dec. 10, 2015

(54) Ladder Tray

(71) Applicant: Timothy S Ellis, Lombard, IL (US)

(72) Inventor: Timothy S Ellis, Lombard, IL (US)

(21) Appl. No.: 14/702,810

(22) Filed: May 4, 2015

Related U.S. Application Data
(63) Continuation-in-part of application No. 29/493,379, filed on Jun. 9, 2014.
Application No. 29/493,379 is a continuation-in-part of application No. 14/310,917, filed on Jun. 20, 2014.

(51) Int. Cl. E06C 7/14

(52) U.S. Cl. CPC E06C 7/14

(57) ABSTRACT

A removable ladder tray on a ladder having a base with a ladder opening formed therein. The ladder tray comprises a base having a top defining an open containment area with a surrounding raised edge to prevent items from falling off the tray. The ladder tray having ribs and ridges extending from the front to the back of the tray and a support ridge on a surrounding wall on the base top. A pyramid shaped ladder box is on the tray collaring the ladder opening, The ladder box adapted to surroundingly fit around the ladder, holding the base top generally horizontally extending away from the user thereby allowing full use and access to the all the climbing rungs and the top platform on top of the ladder.

### BACKGROUND OF THE INVENTION

The present invention relates to a ladder-mounted tray for holding tools and materials needed for work while on the ladder. In the prior art, it is known to provide a ladder with a separate detachable tray that is mounted on the ladder in any one of a variety of ways. Some such devices rely upon the openings within the ladder's rungs to support the tray. Others rely upon the brackets or fasteners on the rungs or ladder head to support a tray. Still others rely upon the side rails of the ladder or combinations of the side rails, rungs and openings through rungs for support purposes. Generally, a user climbs to the upper end of the ladder to perform work. On a standard ladder there is nothing at the upper end of a ladder for carrying tools.

Many attempts have been made to provide some form of ladder tray for easy attachment and removal to the upper end of the ladder for holding tools and materials. In particular, ladders may be ten or twenty feet long and relatively heavy making it difficult to traverse the ladder each time a new tool is needed or to replenish working supplies. It is necessary for the user to position the ladder and climbed to the top to attach the ladder tray. Prior art devices require the user climb to the top of the ladder and use fasteners or tools to attach a ladder tray. Further, the ladder tray may shield portions of the ladder, preventing full functionality to the user or creating a dangerous situation.

Accordingly, it is desirable to provide a ladder tray which may be attached to the top of the ladder without tools, while providing an interlocking fit to prevent the ladder tray from tipping. Further, it is desirable to provide a ladder tray which provides access to all of the rungs on the ladder including the top shelf on top of the ladder head.

### SUMMARY OF THE INVENTION

The present invention relates to a ladder tray for use on a ladder. The ladder may have two front legs and two back legs. The front legs and back legs pivotally attached to each other at a ladder head. When deployed in a usable configuration the ladder head allows the front legs having climbing rungs thereon to pivot about the ladder head with respect to the back legs to form an A-frame shaped stand alone step-ladder for a user. Generally, climbing rungs are disposed on the front legs. The present invention, in a first embodiment comprises a removable ladder tray on the ladder having a base with a ladder opening formed therein. The base may comprise a plurality of ribs extending from the ladder engagement portion to a front edge of the ladder tray. A ridge may be disposed between adjacent ribs thereby giving the base a wavy cross-section. he ladder opening is generally rectangular and disposed adjacent the back of the tray. The ladder opening has two spaced apart side edges and two spaced apart ladder leg sides. The smaller sides edges may bear against the outside of the respective ladder legs.

The ladder tray comprises a base having a top defining an open containment area with a surrounding raised edge to prevent items from falling off the tray. A horizontal ridge may be disposed on the raised edge. The ladder is inserted into the ladder opening having the ladder head above the tray and the climbing rungs below the tray. The ladder opening surroundingly fits around the ladder adjacent to and just below the ladder head thereby allowing full use and access to the all the climbing rungs and the top step located on top of the ladder head. A ladder box surrounds the ladder opening on the tray having obliquely angled front and back walls to fit flush against the ladder legs. The ladder box acts as a collar to engage the ladder and provide support for the ladder tray. The raised edge may surround the containment area and the ladder box.

The ladder box comprises interconnected walls surrounding the ladder opening. The ladder box has a top and a bottom, the bottom is of similar size and shape as the ladder opening, the top is of similar shape as the bottom but may be smaller to snugly fit over the A-shaped step ladder. The ladder box may have two spaced apart vertical walls on the side edges of the ladder opening adapted to bear against the respective sides of ladder. The ladder box further has an obliquely angled support wall and an obliquely angled back wall. The support wall may comprise a bottom on the base and a top adapted to engage and bear against the back legs, the back wall may have a contoured raised edge adapted to bear against the ladder head. The back wall may have a low profile. The ladder head extends through the ladder box to provide access to the user.

Work items such as tools, paint, glue, etc. may be placed on the base causing the tray to pivot slightly about the connection point to the ladder. This pivoting motion may cause the top of the back wall to move upward towards the ladder head thereby engaging and bearing against the ladder head to hold the ladder tray in place. The sleeve like fitting of the ladder box around the ladder legs supports the tray in a generally horizontal position.

The foregoing is a description of a preferred embodiment of the invention which is given here by way of example only. The invention is not to be taken as limited to any of the specific features as described, but comprehends all such variations thereof as come within the scope of the appended claims.

### DESCRIPTION OF THE DRAWINGS

FIG. 1 is a top perspective view of a ladder tray showing a first embodiment;

FIG. 2 is a top plan view of the ladder tray as shown in FIG. 1;

FIG. 3 is a bottom plan view of the ladder tray as shown in FIG. 1;

FIG. 4 is a left-side elevation view of the ladder tray as shown in FIG. 1, the right-side elevation view being a mirror image thereof;

FIG. 5 is a front elevation view of the ladder tray as shown in FIG. 1,

FIG. 6 is a top perspective view of the ladder tray as shown in FIG. 1 separated from the ladder;

FIG. 7 is a side elevation view of the ladder tray mounted on the ladder,

FIG. 8 is a top plan view of a second embodiment of the present invention.

FIG. 9 is a side elevation view of the second embodiment of the present invention.

FIG. 10 is a front elevation view of the second embodiment of the present invention.

FIG. 11 is a bottom plan view of the second embodiment of the present invention.

FIG. 12 is a right side elevation view of the second embodiment of the present invention.

FIG. 13 is a back elevation view of the second embodiment of the present invention.

FIG. 14 is a top front perspective view of the second embodiment of the present invention.

FIG. 15 is a back top perspective view of the second embodiment of the present invention.

FIG. 16 is a bottom front perspective view of the second embodiment of the present invention.

FIG. 17 is a bottom back perspective view of the second embodiment of the present invention.

Referring to FIG. 1, the removable ladder tray 10 may comprise a front wall 12, brace 14 and a first side wall 16 and second side wall 18. Front wall 12 is generally perpendicular to to base 20. Brace 14 is obliquely attached to base 20 and spaced from front wall 12. First sidewall 16 and second sidewall 18 are generally parallel to each other and spaced apart. Base 20 has a peripheral edge 21 surrounding a working surface 22 of the removable ladder tray 10. First sidewall 16 extends between front wall 12 and brace 14. Second sidewall 18 extends between front wall 12 and brace 14. Together, front wall 12, brace 14 and first and second sidewalls 16, 18 are attached to the periphery of base 20 and each other to form a continuous wall 23 surrounding the base top 22.

Continuing to refer to FIG. 1, a ladder opening 24 is formed by removing material to create a hole in base 20 adjacent back edge 25 of base 20. A ladder box 26 may be attached to the base top 22 forming a tapered surrounding around the ladder opening 24. The ladder box 26 comprises two box sidewalls 28, 30 attached to and extending upward from and generally perpendicular to base top 22, a support wall 32 obliquely connected to the base top 22 and the two box sidewalls 28, 30. The two box sidewalls 28, 30 may be attached to and extend from support wall 32 to attach to brace 14 to give ladder box 26 a generally tapering shape surrounding and extending above ladder opening 24.

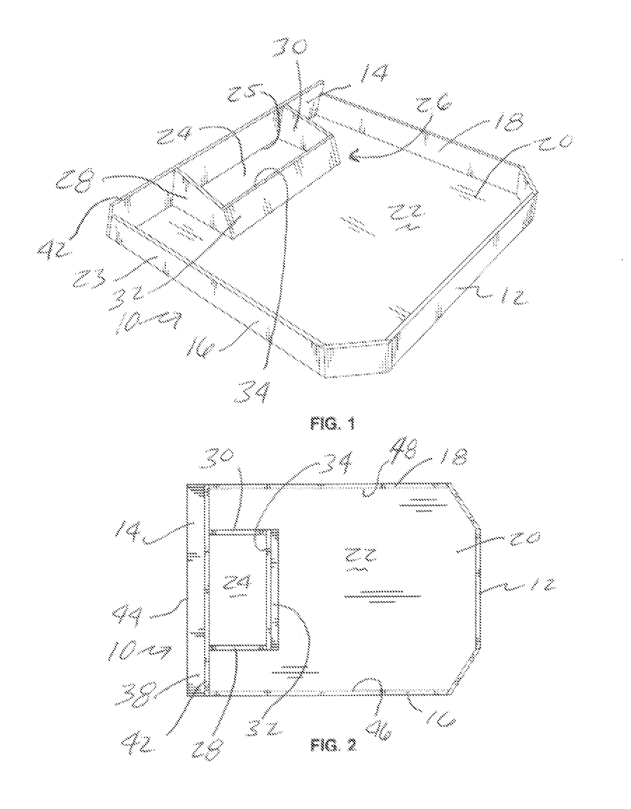

Referring to FIG. 2, the ladder box 26 further comprises a top opening 34 concentric with and smaller than ladder opening 24. Brace 14 further comprises an outside 38, a top 42 and a bottom 44. Brace top 42 may be disposed closer to the support wall 32 than bottom 44 thereby leaning brace 14 over ladder opening 24. Brace 14 may be obliquely attached to base top 22 and ladder box sidewalls 28,30 which are joined by support wall 32 to surround ladder opening 24. First sidewall 16 and second sidewall 18 may further comprise an inside surface 46, 48, respectively, disposed in a generally perpendicular orientation to base top 22.

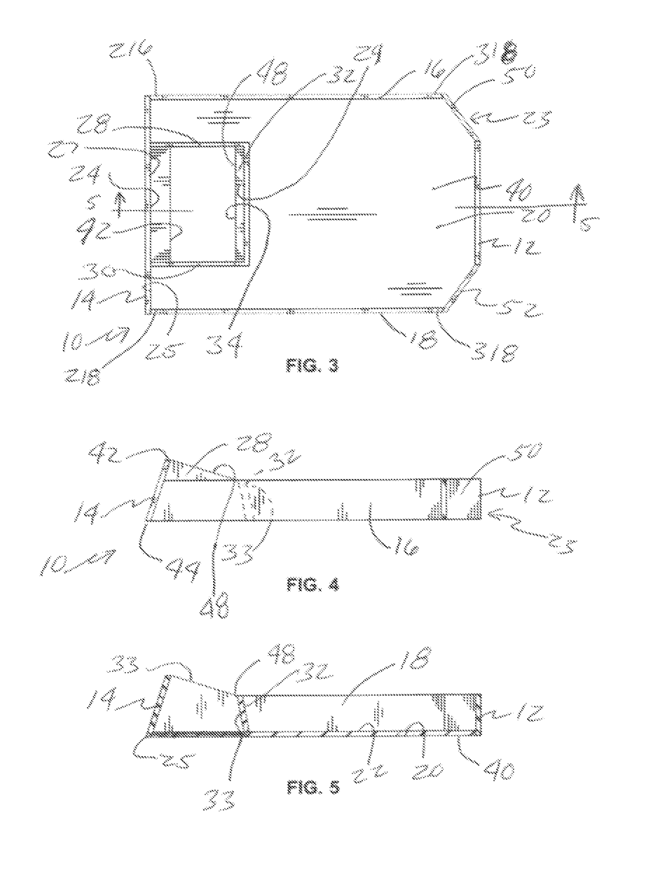

Referring to FIG. 3, the base 20 further comprises a bottom 40. The ladder opening 24 extends through the shelf 20 opening to the bottom 40. The ladder opening 24 has a leading edge 27 and a rung edge 29. The support wall 32 is attached to the base 20 adjacent the leading edge 27. Ladder opening rung edge 29 may open onto back edge 25 and be closed by brace 14. The support wall 32 and brace 14 are obliquely attached to the shelf 20 to form a ladder box top opening 48 smaller than the ladder opening 24. The front wall 12 may further be connected to the first sidewall 16 by first corner piece 50. The front wall 12 may be connected to second sidewall 18 by second corner piece 52. It should be understood, base 20 may be round, triangular or a different shape having a surrounding wall 12, 14, 16, 18 and a ladder opening 24 disposed adjacent to the back edge 25. Brace bottom 44 may be attached to back edge 25. In the preferred embodiment, and brace 14 is straight to fit flush against the ladder (FIG. 8). Box top opening 48 may have a size smaller than ladder opening 24 by the brace 14 and support wall obliquely disposed on base 20. First sidewall 16 and second sidewall 18 may be each attached to the base 20 each having a front end 316, 318, respectively, adjacent the front wall 12 and a back end 216, 218, respectively, on the brace 14.

Referring to FIGS. 4 and 5, ladder box 24 may comprise a box bottom 33 on base 20 and a box top opening 48 spaced from the base 20. Brace 14 may be larger than front wall 12 extending further above base bottom 40. Support wall 32 is attached to base 20 having leg surface 33 disposed at an oblique angle A to top 22. The support wall 32 further comprises a support top 34 and a support bottom 36. Support wall 32 is obliquely attached to base 20 having support top 34 disposed closer to brace 14 than support bottom 36 thereby leaning support wall 32 toward brace 14 and over ladder opening 24. Support wall 32 may extend to a similar height as first and second sidewalls 16, 18. First and the second ladder box sidewalls 28, 30 may have a trapezoidal shape to extend from base top 22 and connect support wall 32 and brace 14. Top edge 41 of first box sidewall 28 may be disposed at an acute angle to top 22 connecting support wall top 34 to brace top 42.

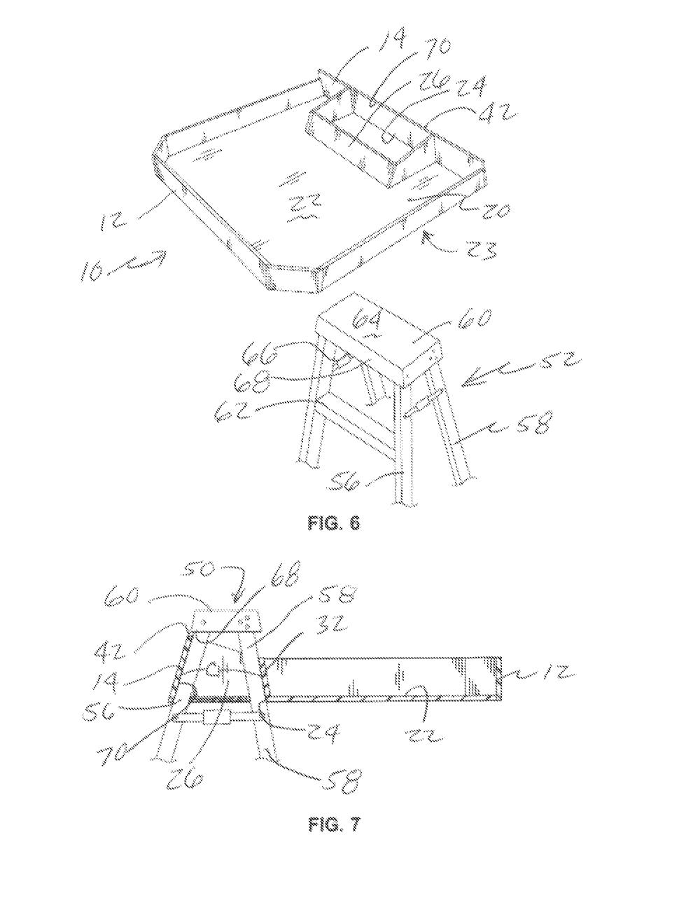

Referring to FIG. 6, the ladder tray 10 may be formed of metal or plastic. The ladder tray 10 may be formed of a single integrated molded material such as plastic molding or may be assembled bu means such as welding or adhesives used to connect the base 20 to the surrounding edge 23 and the ladder box 26. The front wall 12, brace 14 and sidewalls 16, 18 may be attached to base 20 in an I-beam type configuration to provide more support, further additional beams (not shown) may be extended from the brace 14 to the front wall 12 for additional support. Ladder 52 comprises a pair of front legs 56 and back legs 58. Front legs 56 may be joined by climbing rungs 62 disposed between front legs 56. Front legs 56 may be fixedly attached to the ladder head 60. Ladder head 60 may be disposed at the apex 50 of ladder 52. Back legs 58 may be pivotally attached to ladder head 60 to allow the legs 56, 58 to pivot from a closed position (not shown) to an A-shaped, stand alone step-ladder 52. The ladder box 26 may surround ladder opening 24 having the obliquely disposed sides adapted to press fit securely on ladder 52 between ladder head 50 and the plurality of rungs 62. The ladder head 60 may further comprises a top step 64 and a front lip 66. Front lip 66 is attached to top step 64 and extends downwardly to bottom edge 68 spaced below top step 64 and adjacent front legs 56.

Referring to FIG. 7, the ladder tray 10 may be removably attached to the ladder 52 by extending the top 50 of ladder 52 through the ladder opening 24. Ladder head 60 may be disposed above ladder box top opening 48 having ladder box brace top 42 disposed below and adjacent to front lip bottom edge 68. Ladder surface 70 of brace 14 bears against front legs 56. Likewise, support wall 32 bears against back legs 58. Work material 72 on ladder tray 10 may cause the cantilever ladder tray 10 to pivot about the interface between ladder 52 and ladder opening 24 causing a canting of the ladder tray 10 with the front 12 dropping down and the brace 14 raising up causing the ladder tray 10 to shift from a normal generally horizontal position, this canting may cause the brace top 42 to engage and bear against front lip bottom edge 68 thereby securing ladder tray 10 to ladder 52.

Continuing to refer to FIG. 7, the brace 14 bears against the front legs 56 below the ladder head 50 and above the rungs 62. The oblique angle C between brace 14 and support wall 32 may be configured to closely match the angular relationship between front legs 56 and back legs 58 to allow the ladder surface 70 to be flush against front legs 56 and support wall to be flush against back legs 58 whereby the ladder box 26 is press-fitted over the top of the ladder 52.

Referring to FIGS. 8 and 11, the second embodiment of the removable ladder tray referred to as ladder platter 100 may comprise a front wall 112, brace 114 and a first side wall 116 and second side wall 118. Front wall 112 is generally perpendicular to base 120. Brace 114 is obliquely attached to base 120 and spaced from front wall 112. First sidewall 116 and second sidewall 118 are generally parallel to each other and spaced apart. Base 120 has a peripheral edge 121 surrounding a working surface 122 of the removable ladder tray 110. First sidewall 116 extends between front wall 112 and brace 114. Second sidewall 118 extends between front wall 112 and brace 114. Together, front wall 112, brace 114 and first and second sidewalls 116, 118 are attached to the periphery of base 120 and each other to form a continuous wall 123 surrounding the base top 122.

Continuing to refer to FIGS. 8 and 11, a ladder opening 124 is formed by removing material to create a hole in base 120 adjacent brace 114. A ladder box 126 may be attached to the base top 122 forming a tapered shape surrounding 113 around the ladder opening 124. The ladder box 126 comprises two box sidewalls 128, 130 attached to and extending upward from and generally perpendicular to base top 122, a support wall 132 obliquely connected to the base top 122 and the two box sidewalls 128, 130. The two box sidewalls 128, 130 may be attached to and extend from support wall 132 to brace 114 to give ladder box 126 a generally tapering shape surrounding 113 and extending above ladder opening 124. Tapering shape surrounding being larger adjacent base top 122.

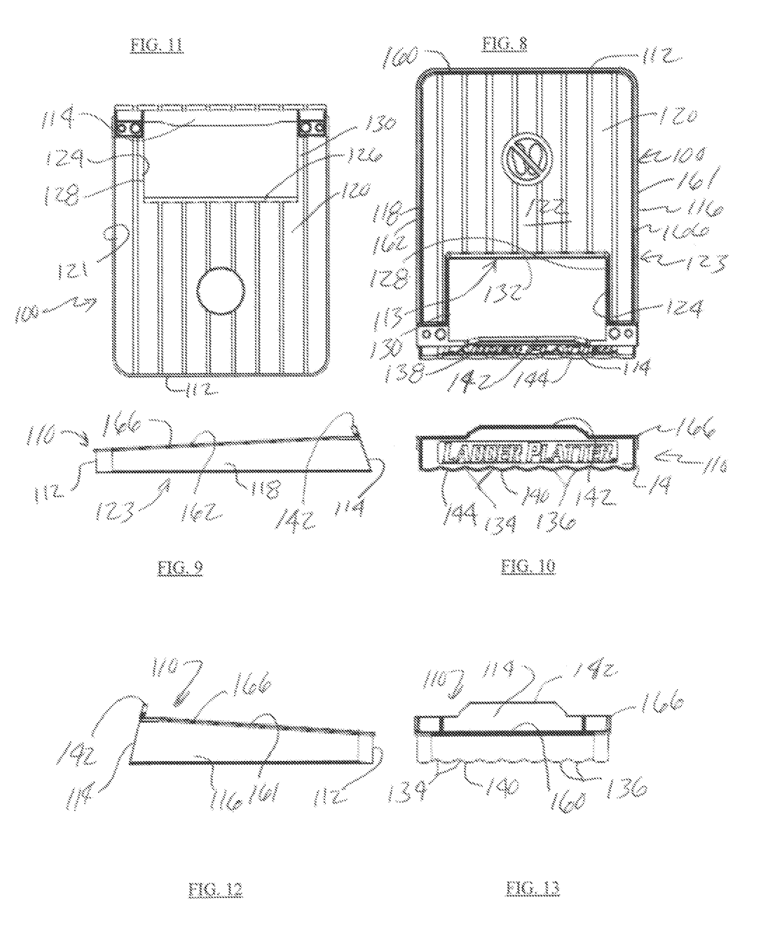

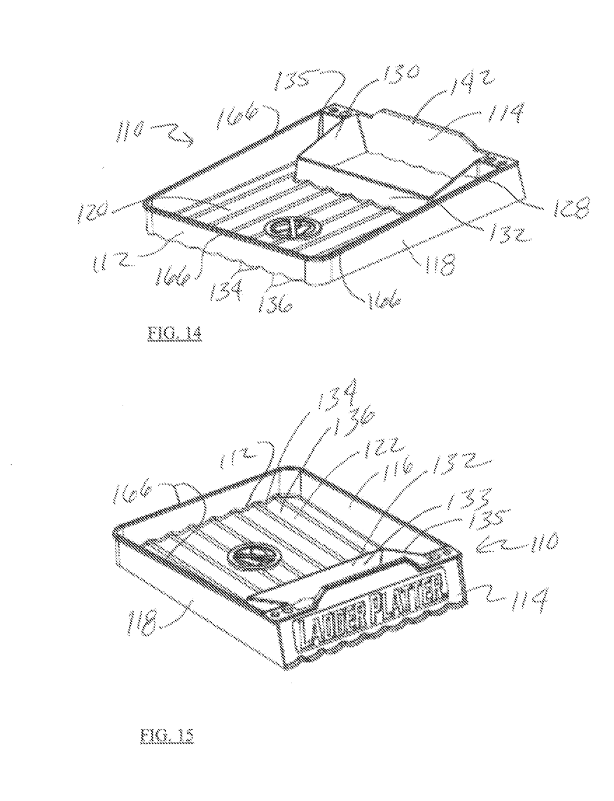

Referring to FIGS. 9 and 12, brace 114 further comprises an outside 138, a top 142 and a bottom 144. Brace top 142 may be contoured and disposed closer to the front wall 112 than bottom 144 thereby leaning brace 114 over ladder opening 124. Front wall 112 may have a front top edge 160. First sidewall 116 may have first top edge 161. Second sidewall 118 may have second top edge 162.

Referring to FIGS. 8, 10 and 13, the base 120 further comprises a bottom 140. Bottom 140 may be formed as a scalloped shape comprising a series of curved projections having ribs 134 and ridges 136 running parallel to each other form the front wall 112 to brace 114. scalloped ribs 134 and ridges 136 may extend to front wall 112 and brace 114 or front wall 132. A rectangular shaped top ridge 166 may be formed on along top edges 160, 161 and 162, having a long edge on the ladder tray 110 parallel and extending outward from base 120 thereby surrounding ladder tray 110 on three sides. Top ridge 166 is spaced from base top 122. Brace top 142 may have a contoured shape adapted to engage ladder 52 (FIG. 6).

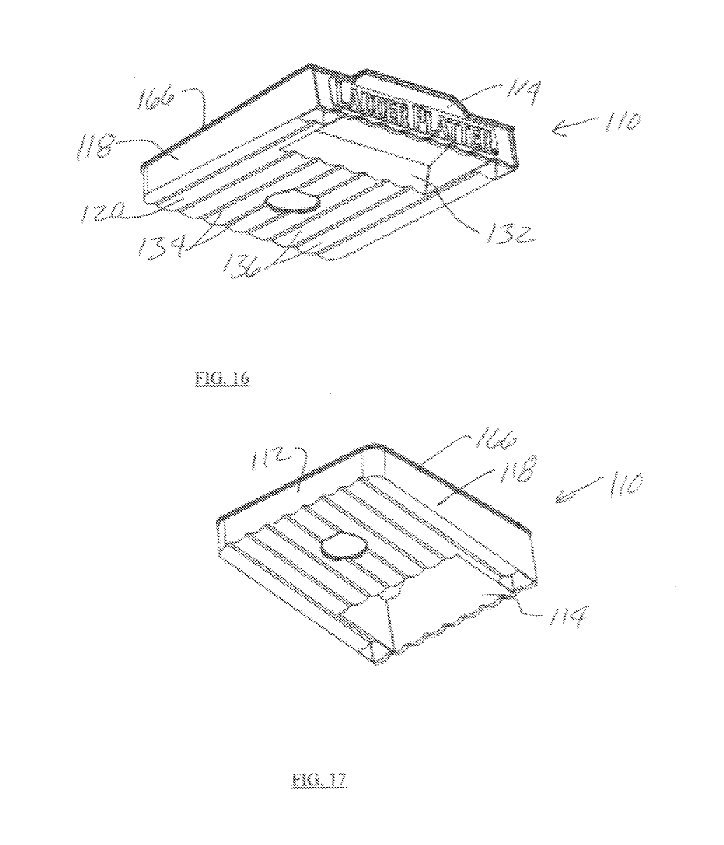

Referring to FIGS. 14 and 15, ladder box 124 may comprise a box bottom 133 on base 120 and a box top opening 148 spaced from the base 120. Brace 114 may be larger than front wall 112 extending further above base bottom 140. Support wall 132 is attached to base 120 having leg surface 133 disposed at an oblique angle to top 122. Support wall 132 further comprises a support top 135 and a support bottom 136. Support wall 132 may be obliquely attached to base 120 having support top 135 disposed closer to brace 114 than support bottom 136 thereby leaning support wall 132 toward brace 114 and over ladder opening 124. Support wall 132 may extend to a similar height as first and second sidewalls 116, 118. First and the second ladder box sidewalls 128, 130 may have a trapezoidal shape to extend from base top 122 and connect support wall 132 and brace 114. Top edge 141 of first box sidewall 128 may be disposed at an acute angle to top 122 connecting support wall top 135 to brace top 142. Utility holes 143 may be formed in brace 114 for holding tools (not shown).

Referring to FIGS. 16 and 17, ladder opening 124 extends through the shelf 120. Ladder opening 124 has a leading edge 127 and a rung edge 129. The support wall 132 is attached to base 120 adjacent leading edge 127. Support wall 132 and brace 114 are obliquely attached to the shelf 120 to form a ladder box top opening 148 which is smaller than ladder opening 124. Front wall 112 may further be connected to first sidewall 116 by first corner piece 150. Front wall 112 may be connected to second sidewall 118 by second corner piece 152 forming a contiguous base top wall 121 surrounding top 122. It should be understood, base 120 may be round, triangular or a different shape having a surrounding wall 112, 114, 116, 118 and a ladder opening 124 disposed adjacent to the back edge 125. Brace bottom 144 may be attached to back edge 125. In the preferred embodiment, and brace 114 may be contoured to bear against bottom edge of ladder head to removably hold ladder tray 110 on ladder (FIG. 8). Box top opening 148 may have a size smaller than ladder opening 124 by the brace 114 and support wall obliquely disposed on base 120. First sidewall 116 and second sidewall 118 may be straight and generally parallel to scalloped ribs and ridges formed in base 120 extending from front edge.

Continuing to refer to FIGS. 16 and 17, a horizontal ridge 166 on sidewalls 116, 118 and end wall 112 may extend outward from base 120. Horizontal ridge 166 may be formed surrounding base 120. Brace 114 has contoured top 148 adapted to engage ladder head (FIG. 7). Ribs 134 extend from front 112 to brace 114 or support wall 132 and are interspersed with ridges 136. Ribs 134 are separated from adjacent ribs 134 by a ridge 136. Likewise, a rib 134 is formed between each pair of adjacent ridges 136 to form a scalloped shaped construction between front 112 and brace 114. Ridges extend from front wall 112 to support wall 132 or brace 114.

In use and referring to FIG. 7, the removable ladder tray 10 may be removably attached to ladder 52 without tools or fasteners. Ladder head 60 is disposed in ladder opening 24. brace 14 is adapted to engage ladder head 60 and force front legs against support wall 32. Gravity acting on base 20 forces a cantilevered action of the ladder tray 10 about ladder 52 thereby urging brace to hold connection between ladder head 60 and brace 14 to secure ladder tray 10 to ladder 52. Lifting front wall 12 pivots ladder tray 10 about the connection with ladder 52 thereby disengaging brace 14 from ladder head 60 whereby ladder tray 10 may be lifted off ladder 52 to separate ladder tray 10 from ladder 52.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

I claim:

1. A removable ladder tray comprising:
a base comprising a top, a bottom, a front edge, a back edge and a peripheral edge, a ladder opening extending from the top to the bottom, a plurality of ribs formed in the base, the ribs extending from the back edge; and
a brace on the back edge extending from the top, the brace adjacent the ladder opening.

2. The invention of claim 1, further comprising a peripheral wall on the peripheral edge.

3. The invention of claim 1, further comprising a ladder box on the top, the ladder box surrounding the ladder opening, the ladder box on the brace.

4. The invention of claim 3, further comprising a plurality of ridges on the base, each of the plurality of ridges extending from the front edge, each of the plurality of ridges adjacent to and spaced between two of the plurality of ribs.

5. The invention of claim 3, wherein the ladder box further comprises a support wall and a first and second box sidewalls, the support wall spaced from the brace, the first and second sidewalls on the brace.

6. The invention of claim 4, wherein the ladder box further comprises a support wall and a first and second box sidewalls, the support wall spaced from the brace, the first and second sidewalls on the brace.

7. The invention of claim 2, further comprising a horizontally disposed ridge on the peripheral wall.

8. The invention of claim 6, further comprising a first and second sidewall on the base, each of the first and second sidewalls on the brace, a horizontally disposed ridge on the first and second sidewalls.

9. The invention of claim 8, further comprising a front wall on the base, the front wall extending from the first sidewall to the second sidewall.

10. The invention of claim 9 further comprising a horizontally disposed ridge on the front wall.

11. A removable ladder tray for removably attaching to a ladder having a ladder head at a ladder top end, the removable ladder tray comprising,
a base comprising a top, a bottom, a back edge and a front edge, a ladder opening in the base extending from the top to the bottom; and
a brace on the top adjacent the ladder opening, the brace adjacent the back edge, the ladder opening adapted to surroundingly engage the ladder top end, the brace adapted to removably engage the ladder.

12. The invention of claim 11, further comprising a ladder box on the top, the ladder box surrounding the ladder opening, a base wall surrounding the top, a top ridge on the base wall.

13. The invention of claim 12, wherein the top ridge is spaced from the top.

14. The invention of claim 11, wherein the base further comprises a plurality of ribs extending from the front wall.

15. The invention of claim 12, wherein the ladder box further comprises a support wall on the top.

16. The invention of claim 15, wherein the base further comprises a plurality of ribs extending from the front wall to the support wall.

17. The invention of claim 16, wherein the ladder box further comprises a support wall on several of the plurality of ribs.

18. The invention of claim 16 further comprising a plurality of ridges on the base, each one of the plurality of ridges disposed between adjacent ones of the plurality of ribs, each one of the plurality of ridges generally parallel to each one of the plurality of ribs, each one of the plurality of ridges extending from the front wall.

19. The invention of claim 11, further comprising a plurality of ribs on the base and a plurality of ridges formed in the base, each of the plurality of ridges disposed between two adjacent ones of the plurality of ribs.

20. A ladder tray for removably attaching to a ladder having a ladder head, the ladder tray comprising:
a base having a top, a bottom, a back, a front and a peripheral edge, a brace on the back, material removed from the base to form a ladder opening extending from the top to the bottom, the brace adjacent the ladder opening, the brace having a bottom on the base and a top, the top adapted to engage the ladder head, a ladder box on the top, the ladder box comprising a support wall on the top spaced from the brace, the ladder box surrounding the ladder opening;
a plurality of ribs and ridges formed in the base and extending from the front to the back, each one of the plurality of ribs formed between a pair of adjacent ones of the plurality of ridges, each one of the plurality of ribs generally parallel to each one of the plurality of ridges wherein the base has a scallop shaped cross-section;
a wall surrounding the base top, the wall on the base, a top ridge on the wall spaced from the top.
